(19) United States
(12) Patent Application Publication
(10) Pub. No.: US 2026/0308779 A1
(43) Pub. Date: Oct. 8, 2026

(54) Casing Structure Design for Electrolytic Cells

(71) Applicant: Viering, Jentschura & Partner mbB Patent- und Rechtsanwälte, München (DE)

(72) Inventors: Daniele Nuzzo, Milan (IT); Silvia D'Amato, Milan (IT); Michele Perego, Milan (IT); Mirko Liuzzo, Milan (IT)

(21) Appl. No.: 19/481,479

(22) PCT Filed: Apr. 30, 2024
(86) PCT No.: PCT/EP2024/061878

§ 371 Date: Nov. 4, 2025

(30) Foreign Application Priority Data
May 10, 2023 (IT) 102023000009330

(51) Int. Cl. C25B 9/63; C25B 1/04; C25B 9/75

(52) U.S. Cl. CPC C25B 9/63; C25B 1/04; C25B 9/75

(57) ABSTRACT

The present invention concerns composite casing structures for electrolytic cells wherein each casing structure is made of a plurality of casing components, optionally made of at least two different materials, which are subsequently joined together to form a structure suitable to house one or more of the following elements: electrodes, separators, bipolar elements, elastic elements and/or current collectors. The casing structure may be advantageously employed in electrolysers for high pressure alkaline water electrolysis.

### FIELD OF THE INVENTION

The present invention concerns a new composite casing structure design which may be advantageously employed in alkaline water electrolysis (AWE) cells and a method for producing the same. The present invention also relates to an electrolyser for alkaline water electrolysis equipped with the cells provided with a new composite casing structure design.

### BACKGROUND OF THE INVENTION

Electrochemical industrial applications often require electrolysers comprising a plurality of electrochemical cells, in electrical and hydraulic connection, each cell being provided with opposite electrodes facing each other and immersed in a current conductive liquid media, the electrolyte.

In many industrial electrolysers, individual electrodes are housed within a supporting casing structure, within a specially designed housing cavity to allow direct contact between the electrode surface and the electrolyte while ensuring its correct positioning within the cell and with respect to the other functional elements contained therein. The electrolyte is fed to the electrode and subsequently discharged via one or more channels, or manifolds, that in some instances may traverse each casing structure and may be designed to put the cells in parallel hydraulic connection.

In a variety of applications, such as for instance industrialized pressurized AWE electrolysers, the casing structures may exhibit relatively large surface areas, such as 2-8 m² (including any holes and void areas that may be enclosed therein). They also need to withstand challenging operating conditions, in terms of pressure and chemical stability, preferably without detriment to their overall weight and cost.

Furthermore, the casing structures in the above scenario will be likely provided with a variety of through holes, or void areas, for example for the internal manifold, if present, and for the housing cavity. The casing structures may also include channels to direct the flow of the electrolyte towards/from internal manifold from/to the housing cavity and the electrode supported therein (and/or from/to any other relevant element of the cell housed in the housing cavity).

It is understood that here and in the following the expression “casing structure” indicates the support structure within an electrolytic cell that is designed to support and suitably arrange within the cell cavity any of the following elements, alone or in combination, for the purpose of optimizing their mutual interaction (from a chemical, electrical and fluid dynamic standpoint), as well as their handling and placement: an anode, a cathode, an elastic element, a bipolar element, a current collector, and a separator (such as a diaphragm or membrane).

Usually, casing structures of electrolytic cells are made of a single piece/component and are manufactured by molding or by machining of semi-finished sheets. Depending on their size, they may be made of plastic or metallic materials.

However, the sheets machining is limited by the dimensions of the sheets available on the market. These are usually rectangular in shape, with at least one side being less than 1 m in size when the following state of the art materials are concerned: Polyether Ether Ketone (PEEK), Polyphenylene Sulfide (PPS), Polysulfones (PSU), and Polyphenylsulfone (PPSU).

In addition, sheets machining produces a lot of wasted material, depending on the shape of the casing structure and the presence of voids on its surface, and is not suited for mass production due to manufacturing time and cost.

On the other hand, molding is a cheap and effective technique when manufacturing small components, i.e. components with an overall size of less than 2 m². When increasing the component dimensions, the molding requires machines and tools that are rarely available in the industry and in any case have a noticeable impact on the costs. The upfront investments to test the products and manufacturing the mold will strongly depend on size. In addition, the high-performance plastic materials particularly suited for AWE applications used for state-of-the-art casing structure manufacturing-such as PEEK, PSU, PPS, PPSU-are expensive and scarce. The cost of materials is an additional reason why the cost of molded casing structures rises steeply with its dimensions.

Metal casing structures, on the other hand are more commonly used for large components, i.e. casing structure with an overall size up to 5 m² or more. Metallic materials suited for AWE applications, such as nickel, nickel-based stainless-steel alloys, nickel plated carbon steel are heavy and expensive (even if their cost per gram is lower than that of PEEK, PSU, PPS, and PPSU, metal casing structures employ larger quantities of raw material, which eventually impacts on the overall price of the component).

The skilled person will appreciate that once manufactured, large casing structures will also be heavy and cumbersome to transport, which will also impact on their final cost. Larger casing structures will also be more prone to damages, due for instance to bending or other deformations that may occur in transit.

It is therefore desirable to have a casing structure for AWE applications that minimizes both the production of scraps and the overall quantity of expensive materials used. Furthermore, it is desirable that the casing structures may be manufactured without resorting to very expensive techniques. It is also desirable to have a casing structure that is easy to pack and transport to the desired locations, to be assembled on site, thereby reducing their carbon footprint.

### DETAILED DESCRIPTION

Under one aspect, the invention relates to a composite casing structure for a water electrolysis cell, the casing structure being composed of at least two casing components that are joined together to form said major surface, and with at least one casing component being made of a plastic material. The casing structure maintains the overall shape, geometry, and functionalities of a single component casing structure, despite being divided into a plurality of originally separate components, which may be made of different materials. Once joined together, the plurality of components forms a substantially coplanar continuum, save for any voids or channels within/across the casing structure. Each casing component is joined to at least one other casing component forming the casing structure. The junction between the two components can be a releasable or fixed joint or a combination thereof.

The material selected for each component shall be adequate to its position within the cell. For example, all components partially or completely in contact with the electrolyte shall be made of a chemically compatible material.

If the interface of two components is in contact with the electrolyte, such interface needs to be liquid-and gas-tight. This may be achieved using gaskets, for example.

The major surface of the casing structure according to the invention is provided with one or more void areas. By void area it is meant a through hole formed on the major surface that extends across the entire thickness of the casing structure and forms a continuous empty space. The total void area Av is calculated by summing up the areas projected by any and all void spaces of the casing structure (i.e. the light of the through holes) onto its major surface.

The void areas comprise one housing cavity suitable to support any of the following cell elements, alone or in combination: an anode, a cathode, an elastic element, a bipolar element, a current collector, and/or a separator (such as a diaphragm or membrane).

The housing cavity is completely enclosed within the perimeter of the major surface and is usually located in its central part. It may be provided with appropriate contouring around its edges to suitably hold an electrode and/or any of the other supportable elements hereinbefore described. The void area of the housing may allow exposing the electrode surface to the electrolyte and to foster the electrochemical reaction on both sides of the electrode, regardless of whether the electrode itself is housed in the housing cavity or is facing a functional supportable element of the cell housed therein. The electrode may be for instance pressed against such element, or in electric/electrolytic connection.

Other optional void areas may include manifolds apertures or empty spaces for the insertion of probes, cables, pipes or other elements necessary for the functioning, maintenance, and/or monitoring of the cell or the electrolyser. The casing components may be further provided with channels suitable to flow the electrolyte from/to the manifold apertures to/from the housing cavity.

The present invention is particularly advantageous in case of large casing structures, especially if provided with one or more void areas. Indeed, the outer perimeter of the major surface of the casing structure according to the invention defines a total area At of 2-8 m² (including any void areas enclosed within said perimeter), and the ratio R of Av with respect to At is 0,25-0,95.

For the avoidance of any doubt, it is understood that the casing structure according to the invention is a three-dimensional object and will have two major opposite surfaces separated by a certain thickness. In general, the casing structure has a negligible thickness compared to its major surfaces. The two opposite major surfaces are equivalent or substantially equivalent to each other for the purpose of this invention, and therefore we refer, here and in the following, to only one of the two, arbitrarily chosen as representative.

Usually, the major surface of the casing structure may be substantially flat or exhibit slight concave or convex profiles, though the skilled person may choose any other profile according to practice.

Analogously, the overall geometry of the casing structures according to the invention may vary. Typically, they either exhibit a circular/oval section or a polygonal shape, such as a square or rectangle, though any shape may in principle be used.

The casing structure according to the invention has the advantage of being made up of several components, each necessarily smaller in size than the overall casing structure. The individual components are therefore easier to manufacture and transport.

Once the individual components are joined together, the resulting casing structure fulfills its purpose of proving a complete support structure for one or more functional elements of the cell (electrodes, current collectors, bipolar plates, separators, elastic elements), thereby ensuring their support, their functional connections (fluid, electric, mechanical and/or electrolytic) and their placement within the cell with respect to the other functional elements present.

A one-piece casing structure with an overall area At of 2-8 m² size as above described would require a very expensive molding and, in the current state of the art, would be difficult or impossible to manufacture with extrusion or additive techniques, such as 3D printing (via Binder Jetting or Inkjet Printing), FDM (Fused Deposition Modeling) or FFF (Fusion Filament Fabrication). Additionally, a one-piece casing structure with a void to solid ratio of R as defined above will generate a considerable and wasteful amount of scraps.

On the other hand, smaller components may have access to the above-mentioned manufacturing technologies and therefore incur in lower production costs. They may additionally reduce the amounts of scraps wasted, either because the components may be advantageously shaped so as to originate the void areas when assembled, and so no amounts of material need to be removed/cut out from the piece, or because the techniques themselves are inherently scarp free. We note that additive manufacturing techniques may be particularly appealing for plastic casing structures prepared for testing purposes.

Transportation and handling of casing structures according to the invention are also facilitated. The risk of incurring into deformation with respect to larger pieces is greatly reduced, since the smaller casing components may be transported separately and assembled on destination.

Additionally, with a composite or fragmented casing structure it is possible to diversify the materials used, based on the position and function of each casing component with respect to the other elements of the cell and its areas of contact with the electrolyte.

It is noted that if the casing components are such that at least one of the larger void areas (typically the housing and/or the manifolds), is not completely contained within one casing component but belongs to at least two components (i.e. it is formed through the assembly of a plurality of components), the amount of scraps is greatly reduced regardless of the manufacturing technique. Therefore, in a preferred embodiment, at least one void area, preferably the housing cavity (because it is typically the largest void area of the casing structure), is not fully contained within just one casing component, but its perimetral border belongs to at least two casing components.

Under one embodiment, the casing components can be made of a same or a different material, which may be advantageously chosen among the following: nickel, nickel-based stainless-steel alloys, nickel plated carbon steel, steel, stainless steel, Polypropylene (PP), Polyacetylene (PA), Polyphosphoric Acid (PPA), Polyphenylether (PPE), Polyvinyl chloride (PVC), Chlorinated polyvinyl chloride (CPVC), PEEK, PPS, PSU, PPSU, optionally reinforced with fillers such as glass fibers, calcium or graphite spheres. It is noted that in case one casing component is made of metal (such as steel, stainless steel or nickel, including alloys thereof), the at least other component shall be made of a suitable plastic material to avoid an excessively heavy casing structure and to reduce stray currents, as the inventors have observed this side effect to metal casing components, which has a remarkably negative impact in AWE applications.

Indeed, metal casing structures and metal casing components may negatively impact the plant performance because of higher stray currents and the release of metal ions into the electrolyte polluting the catalyst.

Therefore, under a preferred embodiment, the casing structure shall be exclusively made of plastic, which may be advantageously chosen from the group consisting of: Polypropylene (PP), Polyacetylene (PA), Polyphosphoric Acid (PPA), Polyphenylether (PPE), Polyvinyl chloride (PVC), Chlorinated polyvinyl chloride (CPVC), PEEK, PPS, PSU, PPSU, optionally reinforced with fillers such as glass fibers, calcium or graphite spheres.

Under a second embodiment, the casing components are made of at least two different materials, provided that at least one is made of plastic. For example, the casing components that are not in contact with the electrolyte and do not have to withstand challenging operating conditions may be advantageously made of PP, PA, PPA, PPE, PVC, CPVC, steel, stainless steel. On the other hand, the parts that are in contact with the electrolyte can be advantageously made of PEEK, PPS, PSU, PPSU, nickel, nickel-based stainless-steel alloys, nickel plated carbon steel, optionally reinforced with fillers such as glass fibers, calcium or graphite spheres.

The above choice of materials allows multiple advantages. First, the more expensive and performing materials required to ensure adequate lifetime performances to the cell are used in lesser amounts, and only where needed, with a positive impact on the costs. Second, the casing structure thus obtained is made, in toto or in part, of plastic materials; hence it will be lighter than an all-metallic counterpart and exhibit lower stary currents, if any.

The individual casing components may be joined together via permanent or semi-permanent joining means, such as: welding, vulcanization, curing, heating, adhesive bonding, riveting, and fixed interlocking systems, such as expandable or deformable fixed joints. With the terms “permanent or semi-permanent” it is meant a joint where it is impossible or very difficult to disassemble the joined components without rupturing them. In addition, or in alternative, the casing components are joined together via releasable joining means, i.e. means that can be unlocked or opened without substantial detriment to the integrity of the casing components. Examples of releasable joining means are stitching, bolting, stapling, and pressurized, magnetic or electromagnetic means.

During assembly, different joining mechanisms may be used between a given pair of casing components, i.e. a plurality of releasable or permanent joining means, or any combination thereof.

According to another embodiment, the casing structure according to the invention comprises at least two assemblies: an external casing component assembly and an internal casing component assembly. The external assembly comprises one or more external casing components of a same first material, making up 50-100% of the area defining the outer perimeter of the major surface of the casing structure. The external assembly does not include any part of the perimeter of the housing cavity.

The internal assembly comprises one or more internal casing components made of a second material more resistant to chemical corrosion than the first material and forming the perimeter of the housing cavity. The internal assembly is either in one-piece (en bloc) or its components are joined together with air-tight and liquid-tight joining means, since this area is likely in contact with the electrolyte (either the anolyte or catholyte). For this reason, it may be advantageous to choose chemically resistant materials as second materials.

Under one embodiment, for the purpose of optimizing the cost of materials, the first material may advantageously be chosen from any of the following plastics or metals: PP, PA, PPA, PPE, PVC, CPVC or steel, stainless steel, while the second material may be chosen from nickel, nickel-based stainless-steel alloys, nickel plated carbon steel or plastics like PEEK, PPS, PSU, PPSU, optionally reinforced with fillers.

It is understood that at least one of the internal or external assemblies in the above embodiment shall be made of plastic.

Preferably, both the internal and the external assembly are made of plastic materials. In particular, the first and second materials may be advantageously chosen among the following pairs: PP-PEEK, PP-PPS, PP-PSU, PP-PPSU, PA-PEEK, PA-PPS, PA-PSU, PA-PPSU, PPA-PEEK, PPA-PPS, PPA-PSU, PPA-PPSU, PPE-PEEK, PPE-PPS, PPE-PSU, PPE-PPSU, PVC-PEEK, PVC-PPS, PVC-PSU, PVC-PPSU, CPVC-PEEK, CPVC-PPS, CPVC-PSU, CPVC-PPSU. It is understood that PEEK, PPS, PSU, PPSU, may be optionally reinforced with fillers.

The internal and external assemblies are either joined together directly with each other or through one or more intermediate casing components made of a material different from both the first and second material.

In order to optimize, on one hand, portability and ease of manufacturing of the casing components, and to avoid an excessively complicated assembly procedure, each casing component may be chosen to project on the major surface of the casing structure an overall area Afc equal to 15%-65% of At, which is also conducive to limit the amount of scraps. In calculating the value of Afc, all void areas entirely enclosed in the single casing component shall be included, as these areas univocally belong to the component.

Under a second aspect, the invention relates to an electrolytic cell for water electrolysis comprising: two casing structures according to any of the embodiments hereinbefore described. A first casing structure hosts a first bipolar element, a current collector and an anode in its housing cavity. A second casing structure hosts one second bipolar element in electrical contact with a cathode. The latter may or may not be housed within the housing cavity. A separator is sandwiched between the anode and the cathode. During operation, an electrolyte will circulate within the cell, specifically an anolyte on the anodic side and a catholyte on the cathodic side.

Under a third aspect, the invention relates to an electrolyser for water electrolysis comprising a plurality of the above-described electrochemical cells, electrically connected to each other. The cells may be also hydraulically connected in parallel via internal manifolds.

Under yet another aspect, the present invention concerns a method for manufacturing the composite casing structure for water electrolysis described above.

The method comprises the steps of:
separately manufacturing each casing component via any of the following techniques: molding, machining, extrusion, casting (in case of metal components), and/or additive manufacturing, i.e. 3D printing (Binder Jetting/Inkjet Printing), FDM (Fused Deposition Modeling) or FFF (Fusion Filament Fabrication), and combinations thereof; and
assembling the casing components together via temporary and/or permanent joining means.

A few embodiments of the invention are described by way of example below with reference to the appended drawings, the purpose of which is solely to illustrate the mutual arrangement of the various elements relating to said embodiments of the invention. The drawings are not to scale. Identical numbers are used to indicate features having the same purpose/effect. The coordinate axis x, y, z, are used in the same fashion throughout all figures. The xy plane is substantially parallel to the two major surfaces of composite casing structures, whereas z is perpendicular to such plane and identifies the main longitudinal axis of the electrolyser according to the invention.

### DESCRIPTION OF THE DRAWINGS

FIG. 1 provides a schematic view of a composite casing structure (100) according to the invention. The casing structure comprises six casing components (111, 112, 113, 114, 151, 152). Two internal casing components (151, 152), constitute the internal assembly (150). The latter contains five void areas: four void areas (202, 203, 204, 205) for the internal manifolds and one for the housing cavity (201). The internal assembly (150) should be made of a suitable material from a chemical and mechanical standpoint, considering that it will be exposed to the electrolyte, as it completely encloses the entire perimetral border (2000) of the housing cavity (201).

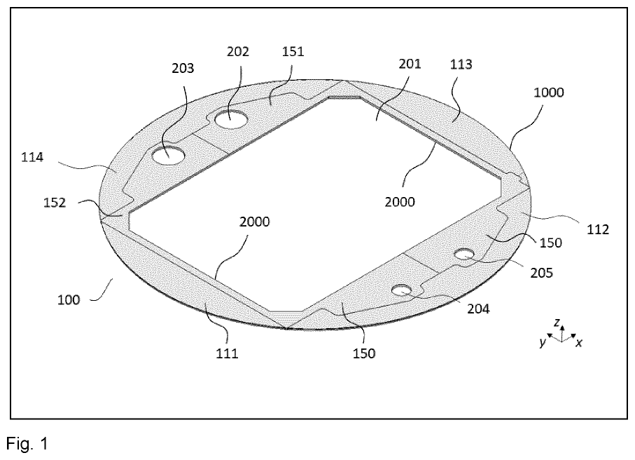

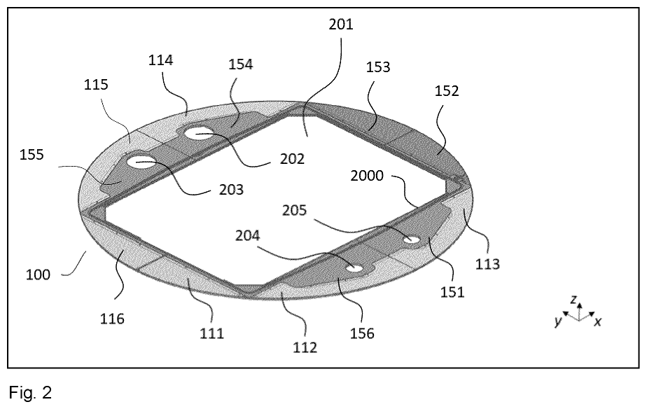

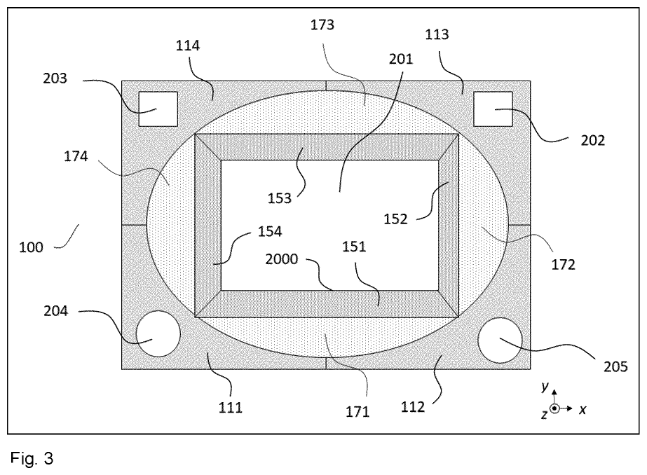

The perimetral border (2000) is segmented and is part of the two internal components (151, 152). Therefore, the housing cavity can be manufactured by suitably shaping the geometry of the internal components (151, 152), thereby limiting the amount of scraps generated for the creation of the housing cavity, regardless of the manufacturing technique. Advantageously, the material for the internal assembly (150) may be chosen among the following plastics, which have been observed to work well in AWE applications: PEEK, PPS, PSU, PPSU, optionally reinforced with fillers (such as glass fibers, calcium or graphite spheres). However, the skilled person will be able to select any suitable alternative given the operating conditions of the cell, taking into account its pressure and temperature, as well as the electrolyte composition. The present embodiment also shows an external assembly consisting of four external casing components (111,112,113,114). The external assembly makes up almost 100% of the outer perimeter (1000) of the casing structure major surface, i.e. one of the two surfaces substantially parallel to the xy plane. It can be made of a less costly and performing material than that of the internal assembly, such as PP. This embodiment allows to tailor the choice (and expense) of the materials used, based on the operating conditions that apply to the different parts of the casing structure, thereby reducing its overall costs. The plastic composition of the different materials chosen for the internal and external assembly also allows to reduce the weight of the casing structure as well as possible stray currents within the cell.

FIG. 2 shows a schematic view of a composite casing structure (100) according to an embodiment of the invention, comprising 12 casing components (111, 112, 113, 114, 115, 116, 151, 152, 153, 154, 155, 156). In particular, 6 internal components (151, 152, 153, 154, 155, 156) form the internal assembly, and 6 external components (111, 112, 113, 114, 115, 116) form the external assembly, with the latter making up roughly 75% of the outer perimeter of the major surface. The major surface of the casing structure has circular shape of 2 m diameter and is provided with 5 void areas (201, 202, 203, 204, 205), including the housing cavity (201) with a ratio R of void-to-fill as hereinbefore defined >0,64. The internal assembly completely encloses the housing cavity (201), but the housing cavity is not contained into one single internal component: its perimetral border (2000) is segmented and belongs to all six internal components. This embodiment reduces the scraps generated by the housing cavity, by fragmenting the internal assembly into 6 components. These must be joined together so as to be air-and liquid-tight. Gaskets, not shown, may be used to this effect.

FIG. 3 shows a planar view of the major surface of a casing structure (100) according to an embodiment of the invention. The casing structure is divided into an external assembly comprising 4 external assembly components (111, 112, 113, 114), an internal assembly comprising 4 internal assembly components (151, 152, 153, 154) and an intermediate assembly comprising 4 intermediate components (171, 172, 173, 174). The casing structure hosts 5 void areas (201, 202, 203, 204, 205), one being the housing cavity (201). The external assembly, the internal assembly and the intermediate assembly are made each of different materials and are joined together with a combination of permanent and releasable means. The casing components are provided with channels (not shown) suitable to the flow of the electrolyte (catholyte or anolyte) to/from the manifold void areas (202, 203)/(204,205) from/to the housing cavity (201).

In the description and the claims in this application the words “comprise” and its variations such as “comprising” and “comprises” do not rule out the presence of other additional elements, components, or stages.

The discussion of documents, deeds, materials, apparatus, articles and the like is included in the text solely for the purpose of providing context for this invention; it should not however be understood that this material or part thereof constitutes general knowledge in the field relating to the invention prior to the priority date of each of the claims appended to this application.

1. A casing structure (100) for a water electrolysis cell having a major surface provided with one or more void areas (201, 202, 203, 204, 205), a total void area Av being the total surface of the one or more void areas projected on said major surface, wherein:
the casing structure (100) is composed of at least two casing components (111, 112, 113, 114, 115, 116, 151, 152, 153, 154, 155, 156, 171,172, 173, 174) which are joined together to form said major surface, with at least one casing component being made of a plastic material, wherein the casing structure (100) maintains the overall shape, geometry, and functionalities of a single component casing structure, despite being divided into a plurality of originally separate components (111, 112, 113, 114, 115, 116, 151, 152, 153, 154, 155, 156, 171,172, 173, 174), wherein, once joined together, the plurality of components (111, 112, 113, 114, 115, 116, 151, 152, 153, 154, 155, 156, 171,172, 173, 174) forms a substantially coplanar continuum, save for any voids or channels within/across the casing structure (100);
the outer perimeter of said major surface defines a total area At of 2-8 m², and the ratio R of Av with respect to At is between 0.25-0.95;
the one or more void areas (201, 202, 203, 204, 205) include a housing cavity (201) situated within the major surface of the casing structure (100) and completely enclosed within a perimeter of the major surface, said housing cavity (201) being suitable to host at least one of the following elements: an anode, a cathode, a separator, an elastic element, a bipolar element or a current collector; and
the one or more void areas (201, 202, 203, 204, 205) is not fully contained within just one of the at least two casing components (111, 112, 113, 114, 115, 116, 151, 152, 153, 154, 155, 156, 171,172, 173, 174), but its perimetral border belongs to the at least two casing components (111, 112, 113, 114, 115, 116, 151, 152, 153, 154, 155, 156, 171,172, 173, 174).

2. The casing structure (100) according to claim 1, wherein the at least one void area (201, 202, 203, 204, 205) that is not entirely enclosed in one single casing component (111, 112, 113, 114, 115, 116, 151, 152, 153, 154, 155, 156, 171,172, 173, 174) but is formed when at least two casing components (111, 112, 113, 114, 115, 116, 151, 152, 153, 154, 155, 156, 171, 172, 173, 174) are joined together is the housing cavity (201).

3. The casing structure (100) according to claim 1. wherein the at least two casing components (111, 112, 113, 114, 115, 116, 151, 152, 153, 154, 155, 156, 171,172, 173, 174) are made of at least two different plastic materials.

4. The casing structure (100) according to claim 3. wherein the at least two different plastic materials are chosen from the group consisting of PEEK, PPS, PPSU, PSU, PP, PA, PPA, PPE, and PVC, employed “as is” or reinforced with fillers.

5. The casing structure (100) according to claim 1. wherein:
at least one casing component is made of a material chosen from the group consisting of PP, PA, PPA, PPE, PVC, CPVC, steel, and stainless steel; and
at least one casing component is made of a material chosen from the group consisting of nickel, nickel-based stainless-steel alloys, nickel plated carbon steel, PEEK, PPS, PSU, and PPSU, employed “as is” or reinforced with fillers;
provided that at least one casing component is made of a plastic material.

6. The casing structure (100) according to claim 1, wherein the at least two casing components (111, 112, 113, 114, 115, 116, 151, 152, 153, 154, 155, 156, 171,172, 173, 174) are joined together via permanent joining means.

7. The casing structure (100) according to claim 6, wherein the permanent joining means are chosen from any of the following techniques or combinations thereof: welding, vulcanization, curing, heating, adhesive bonding, riveting, fixed interlocking systems.

8. The casing structure (100) according to claim 1, wherein the at least two casing components (111, 112, 113, 114, 115, 116, 151, 152, 153, 154, 155, 156, 171,172, 173, 174) are joined together via releasable joining means.

9. The casing structure (100) according to claim 8, wherein the releasable joining means are chosen between any of the following techniques or combinations thereof: stitching, disengageable interlocking, bolting, stapling, magnetic or electromagnetic means, pressurized means.

10. The casing structure (100) according to claim 1, wherein any one of the at least two casing components (111, 112, 113, 114, 115, 116, 151, 152, 153, 154, 155, 156, 171,172, 173, 174) may be temporarily and/or permanently joined with the other.

11. The casing structure (100) according to claim 1 further comprising an external casing component assembly and an internal casing component assembly, wherein:
the external assembly comprises one or more external casing components (111, 112, 113, 114, 115, 116) of a same first material;
said one or more external casing components form 50-100% of the outer perimeter of the major surface of the casing structure (100) and do not include any part of the perimetral border (2000) of the housing cavity (201);
the internal assembly (150) comprises one or more internal casing components (151, 152, 153, 154, 155, 156) made of a second material more resistant to chemical corrosion than the first material;
said one or more internal casing components (151, 152, 153, 154, 155, 156) form the perimetral border of the housing cavity (201) and are en bloc or joined together with air-tight and liquid-tight joining means;
the internal and external assemblies being either joined together directly with each other or through one or more intermediate casing components (171, 172, 173, 174) made of a third material different from both the first and second material.

12. The casing structure (100) according to claim 11. wherein the one or more internal casing components (151, 152, 153, 154, 155, 156) are made of nickel, nickel-based stainless-steel alloys, nickel plated carbon steel or PEEK, PPS, PPSU, PSU, employed “as is” or reinforced with fillers, and the at least one or more external casing components (111, 112, 113, 114, 115, 116) are made of PP, PA, PPA, PPE, PVC, CPVC, steel, or stainless steel.

13. The casing structure (100) according to claim 11, wherein the first and second materials of the external and internal assemblies are respectively chosen among the following pairs of plastic materials: PP-PEEK, PP-PPS, PP-PSU, PP-PPSU, PA-PEEK, PA-PPS, PA-PSU, PA-PPSU, PPA-PEEK, PPA-PPS, PPA-PSU, PPA-PPSU, PPE-PEEK, PPE-PPS, PPE-PSU, PPE-PPSU, PVC-PEEK, PVC-PPS, PVC-PSU, PVC-PPSU, CPVC-PEEK, CPVC-PPS, CPVC-PSU, CPVC-PPSU.

14. The casing structure (100) according to claim 1, wherein each casing component (111, 112, 113, 114, 115, 116, 151, 152, 153, 154, 155, 156, 171,172, 173, 174) projects an overall area of 15%-65% of At.

15. An electrolytic cell for water electrolysis comprising:
a first casing structure (100) according to claim 1 wherein the housing cavity (201) hosts a bipolar element, a current collector and an anode;
a cathode and a separator sandwiched between said anode and said cathode;
a second casing structure (100) according to claim 1 hosting at least one bipolar element in electrical contact with said cathode and an elastic element.

16. An electrolyser for water electrolysis comprising a plurality of electrochemical cells according to claim 15 electrically connected to each other.

17. A method for manufacturing the casing structure (100) for water electrolysis according to claim 1 comprising
separately manufacturing each casing component (111, 112, 113, 114, 115, 116, 151, 152, 153, 154, 155, 156, 171,172, 173, 174) via any of the following techniques: molding, machining, extrusion, casting, additive manufacturing, and combinations thereof; and
assembling the casing components (111, 112, 113, 114, 115, 116, 151, 152, 153, 154, 155, 156, 171,172, 173, 174) together via temporary and/or permanent joining means.
